(19) United States
(12) Patent Application Publication
(10) Pub. No.: US 2010/0300241 A1
(43) Pub. Date: Dec. 2, 2010

(54) OPERATING MECHANISM FOR A PARKING BRAKE

(75) Inventor: Baris BARCIN, Leinfelden-Echterdingen (DE)

Correspondence Address: VENABLE LLP, P.O. BOX 34385, WASHINGTON, DC, 20043-9998, US

(73) Assignee: Dietz-automotive GmbH & Co. KG, Dettingen/Tech (DE)

(21) Appl. No.: 12/787,844

(22) Filed: May 26, 2010

(30) Foreign Application Priority Data
May 26, 2009 (DE) 10 2009 022 656.7

(51) Int. Cl. G05G 1/04

(52) U.S. Cl. 74/523

(57) ABSTRACT

An operating mechanism for a parking brake includes a manual brake lever pivotably coupled to a bearing block; a locking device adapted to secure the manual brake lever in a predetermined pivoting position; an activation rod guided inside the manual brake lever, the activation rod operatively connected to the locking device; and a position-adjustable end stop movable between an engaged position and a released position. The position-adjustable end stop is adapted to delimit pivotable movement of the manual brake lever to a maximum value setting when in the engaged position, and the position-adjustable end stop is adapted to permit movement of the manual brake lever past the maximum value setting when in the disengaged position.

### CROSS-REFERENCE TO RELATED APPLICATIONS

This application claims priority under 35 U.S.C. §119 to German Patent Application No. 10 2009 022 656.7, filed in Germany on May 26, 2009, the entire subject matter of which is expressly incorporated herein by reference.

### BACKGROUND OF THE INVENTION

The invention relates to an operating mechanism for a parking brake.

An operating mechanism of this type is known from German Document DE 195 21 159 C2. This operating mechanism comprises a manual brake lever which is positioned pivoting on a bearing block. The manual brake lever can be moved to the different positions for operating the parking brake with the aid of a locking device comprising a locking segment and a detent.

The manual brake lever is composed of two lever side parts embodied as shell halves. The shell halves are provided on the inside with formed-on parts which make it possible to position the locking device as well as the activation rod. The activation rod in this case is guided inside a tube-shaped part that is formed onto the shell halves, as well as inside the handle.

Bearing bushings in which a bearing tube is guided are incorporated into the shell halves of the manual brake lever. With its longitudinal-side ends, this bearing tube engages in circular openings in the bearing block, thus positioning the manual brake lever on the bearing block in such a way that it can pivot.

With operating mechanisms of this type, a fixed end stop is typically attached to the bearing block which delimits the pivoting movement of the manual brake lever to a maximum value. Primarily, this is necessary since the driver of the vehicle, in particular of a motor vehicle, could otherwise over-rotate the manual brake lever during the operation of the operating mechanism and could thus damage it.

However, providing such an end stop for the pivoting movement of the manual brake lever can result in complications when installing the operating mechanism in the motor vehicle. To install the operating mechanism in the motor vehicle, the bearing block must typically be attached by screwing it to a console of the motor vehicle, wherein the bores for accommodating the screws are located in the bottom of the bearing block. Since the pivoting movement of the manual brake lever is restricted by the end stop, the bores in the bearing block are frequently blocked by the manual brake lever, thus making the installation of the bearing block more difficult and undesirably increasing the expenditure for installing the operating mechanism in the motor vehicle.

### SUMMARY OF THE INVENTION

It is an object of the present invention to provide an operating mechanism of the aforementioned type which can be installed quickly and easily.

According to an embodiment, this object can be solved with an operating mechanism for a parking brake, said operating mechanism comprising: a manual brake lever pivotably coupled to a bearing block; a locking device adapted to secure the manual brake lever in a predetermined pivoting position; an activation rod guided inside the manual brake lever, said activation rod operatively connected to the locking device; and a position-adjustable end stop movable between an engaged position and a released position, wherein the position-adjustable end stop is adapted to delimit pivotable movement of the manual brake lever to a maximum value setting when in the engaged position, and the position-adjustable end stop is adapted to permit movement of the manual brake lever past the maximum value setting when in the disengaged position.

The operating mechanism for a parking brake according to the invention comprises a manual brake lever that is positioned pivoting on a bearing block. With the aid of a locking device, the manual brake lever can be locked in place in a predetermined pivoting position. The operating mechanism is furthermore also provided with an activation rod that is guided inside the manual brake lever and is operatively connected to the locking device. A position-adjustable end stop is provided which can be moved to an engaged position in which it restricts the pivoting movement of the manual brake lever to a maximum value setting. The position-adjustable end stop can furthermore be moved to a released position in which the manual brake lever can be pivoted past the maximum value setting.

On the one hand, the position-adjustable end stop according to the invention delimits the pivoting angle of the manual brake lever to a maximum value setting during the operation of the operating mechanism in a vehicle, in particular a motor vehicle. For this, the position-adjustable end stop is held securely in the engaged position during the operation of the mechanism, thus preventing the manual brake lever from pivoting past the maximum value setting. On the other hand, the position-adjustable end stop can be moved from the engaged position to the released position for installing the operating mechanism in the respective vehicle, in which the manual brake lever can be rotated past the maximum value setting, such that the bottom region of the bearing block is exposed completely. As a result, the bearing block can be installed quickly and easily in the vehicle. It is particularly advantageous that inexpensive standard tools can be used for attaching the bearing block since the bores for inserting the screws into the bearing block are freely accessible as a result of the manual brake lever being rotated past the maximum value setting.

A stop is guided along the manual brake lever which is moved toward the position-adjustable end stop, installed in the engaged position, if the pivoting movement of the manual brake lever corresponds to the maximum value setting.

Owing to this stop and the geometry of the position-adjustable end stop, the maximum value of the pivoting movement is precisely set.

It is particularly advantageous if the position-adjustable end stop is arranged pivoting on the bearing block. With the aid of this pivot bearing, the adjustment of the position-adjustable end stop can be achieved easily and in a cost-effective manner.

According to a particularly advantageous embodiment, the position-adjustable end stop is arranged pivoting on the bearing block, wherein the position-adjustable end stop is held in the engaged position with the aid of a force exerted by a spring element.

An advantage of this arrangement is that the position-adjustable end stop is fixed securely and reproducibly in the engaged position as a result of the spring force exerted by the spring elements, thus ensuring that the position-adjustable end stop delimits the pivoting movement of the manual brake lever to a maximum value setting during the complete period in which the operating mechanism is installed in the vehicle.

A further advantage of this arrangement is that during the installation of the operating mechanism, the position-adjustable end stop delimits the pivoting movement of the manual brake lever to the maximum value setting during the complete operational period for the mechanism installed in the vehicle.

The arrangement furthermore has the advantage that during the installation of the operating mechanism, the position-adjustable end stop can easily be moved to the released position in which the manual brake lever can move past the maximum value setting by pulling it back manually counter to the spring force.

In that case the position-adjustable end stop is not fixated in the released position. Therefore, upon completion of the installation, once the manual brake lever is again pivoted back to the starting position, the position-adjustable end stop is automatically moved back to the engaged position as a result of the spring force. The resetting of the position-adjustable end stop therefore requires no active steps and thus can also not be forgotten during the installation, thereby preventing in the first place a potential error during the installation.

According to another aspect of the invention, the manual brake lever can be pivoted to an overturned position if the position-adjustable end stop is in the released position, wherein this overturned position is predetermined by end stops provided on the bearing block and the manual brake lever.

This operation consequently represents a further safety feature that prevents damage to the mechanism, such that the pivoting movement is restricted to a maximum permissible value determined by the end stops, even during the overturning of the manual brake lever.

It is particularly advantageous if the position-adjustable end stop is a plastic injection-molded part.

### BRIEF DESCRIPTION OF THE DRAWINGS

These and other features and advantages of the invention will be further understood from the following detailed description of the preferred embodiments with reference to the accompanying drawings, showing in:

FIG. 1 An exemplary embodiment of an operating mechanism for a parking brake;

FIG. 2 A representation of the operating mechanism according to FIG. 1, showing a manual brake lever pivoted to a maximum position;

FIG. 3 A representation of the operating mechanism according to FIG. 1, with an overturned manual brake lever;

FIG. 4: A partial representation of the operating mechanism according to FIGS. 1 to 3, showing a position-adjustable end stop in an engaged position;

FIG. 5: A partial representation of the operating mechanism according to FIGS. 1 to 3, showing a position-adjustable end stop in a released position;

FIG. 6: An exemplary embodiment of a position-adjustable end stop with associated spring elements;

FIG. 7: A second exemplary embodiment of a position-adjustable end stop with associated spring elements.

### DETAILED DESCRIPTION OF PREFERRED EMBODIMENTS

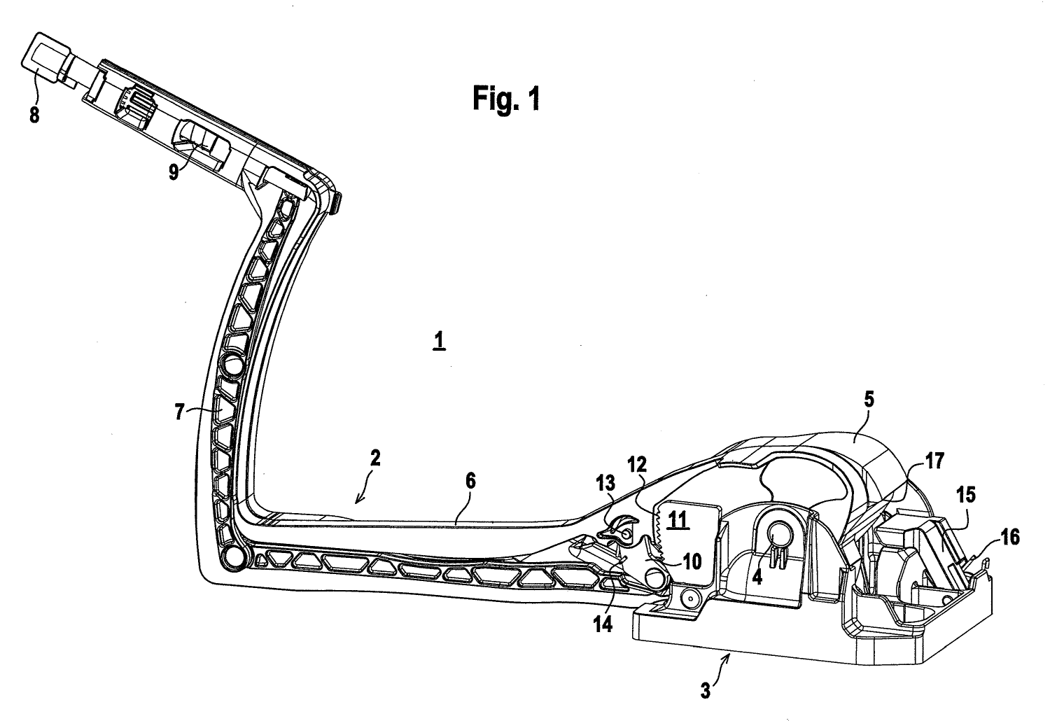

FIGS. 1 to 3 show an exemplary embodiment of the operating mechanism 1 according to the invention for a parking brake used in a vehicle, in particular in a motor vehicle.

The operating mechanism 1 comprises a manual brake lever 2 which is positioned pivoting on a bearing block 3. The bearing block comprises at least one casting, wherein the casting preferably is composed of a light metal alloy. Alternatively, the bearing block can also comprise a plastic injection-molded part.

The manual brake lever 2 may be embodied as an integral casting, wherein this casting is also composed of a light metal alloy. Aluminum alloys or magnesium alloys are preferably used for the bearing block 3 and the manual brake lever 2. In principle, the manual brake lever 2 can also be a plastic injection-molded part. The manual brake lever 2 is positioned rotating around a horizontally extending pivoting axis. A pivot bearing 4 is provided for positioning the manual brake lever 2 on the bearing block 3. A transmission element, not shown herein, is connected non-rotating to the manual brake lever 2.

The respective position of the manual brake lever 2 is transmitted via this transmission element to the vehicle parking brake which is not shown herein. The transmission element for the present case is a rope or cord, but can alternatively also be a cable or rod.

The manual brake lever 2 comprises a basic body 5 that is adjoined by a guide 6 having a displaceable activation rod 7 positioned therein. In the embodiment shown, the activation rod is formed by several rod-shaped plastic parts that are hinged together. The guide 6 takes the form of a U-shaped profile having an open side that is exposed on one side of the manual brake lever 2. As a result of the arrangement of the U-shaped profile opening on the side, the activation rod 7 can be inserted from the side into this guide 6.

A push button 8 is fitted onto the front end of the activation rod 7 which projects over the guide 6 and is secured thereon with the aid of locking means or the like. The push button 8 is used to activate the activation rod 7, in a direction counter to the force of a spring 9.

The activation rod 7 is connected to a locking device by means of which the manual brake lever 2 can be locked in a predetermined pivoting position.

The locking device generally comprises a detent 10 and a locking segment 11. The locking segment 11 is attached to the bearing block 3 and is provided with a strip having detent teeth 12.

The detent 10 is positioned on the manual brake lever 2, to pivot on a bearing pivot 13 around a horizontally extending pivoting axis, and is pre-tensioned via a detent spring 14.

The push button 8 is pushed to release the detent 10 from the locking segment 11, thus displacing the activation rod 7 and releasing the detent 10 in a direction counter to the force of the detent spring 14 from the locking segment 11.

FIG. 1 shows the operating mechanism 1 with the manual brake lever 2 in the starting position in which the manual brake lever 2 is pivoted on the bearing block 3 into the maximum downward position. In this starting position, the parking brake is not effective, meaning it does not exert any braking effect.

If the parking brake is to be used for parking the motor vehicle, the manual brake lever 2 is pivoted upward and is secured in a pivoting position in which the detent 10 engages in a specific position in the locking segment 11.

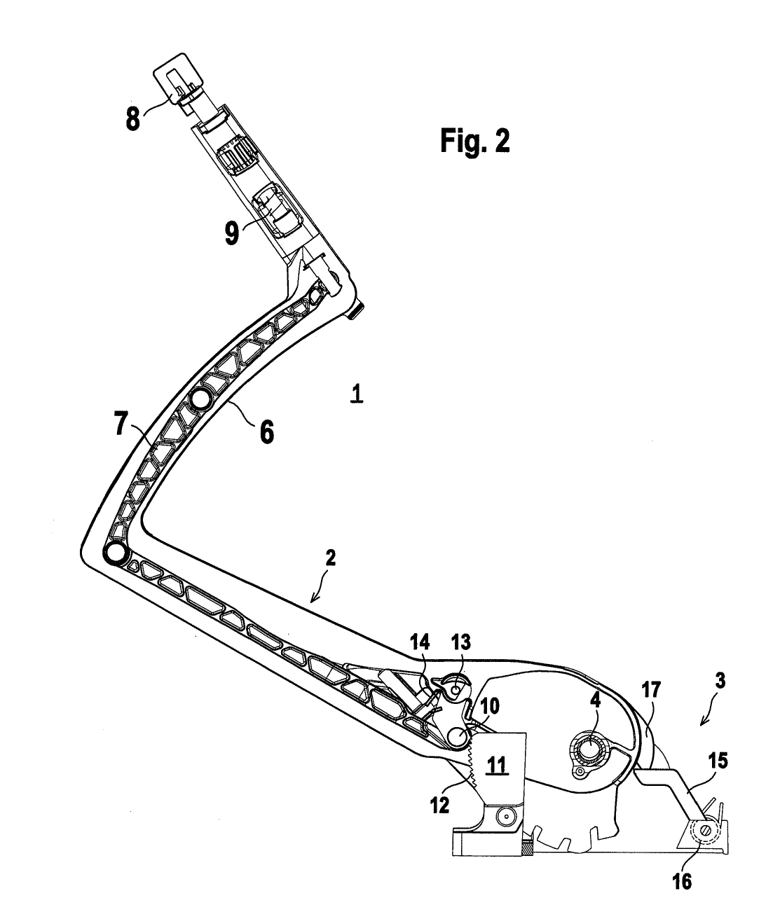

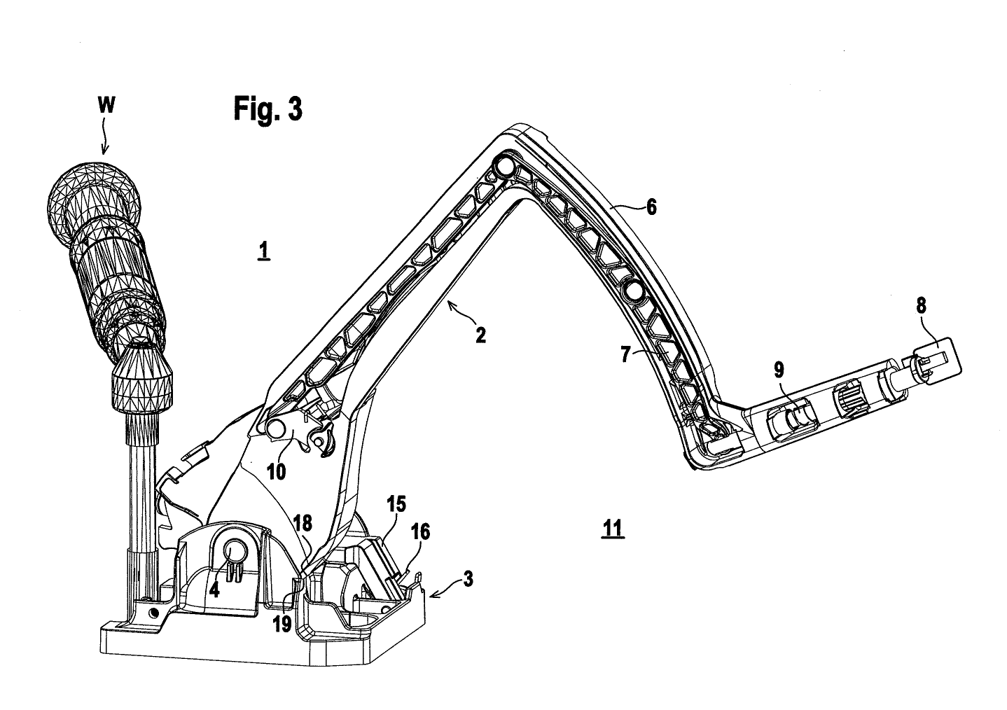

To avoid any overturning of the manual brake lever 2 during the operational period of the operating mechanism 1 in the vehicle, the pivoting movement of the manual brake lever 2 is delimited to a maximum value setting during this operational phase through a position-adjustable end stop 15. FIG. 2 shows the operating mechanism 1 with the manual brake lever 2 in this end position which corresponds to the maximum value setting. FIG. 3, on the other hand, shows the operating mechanism 1 with the manual brake lever 2 pivoted past the position corresponding to this maximum value setting.

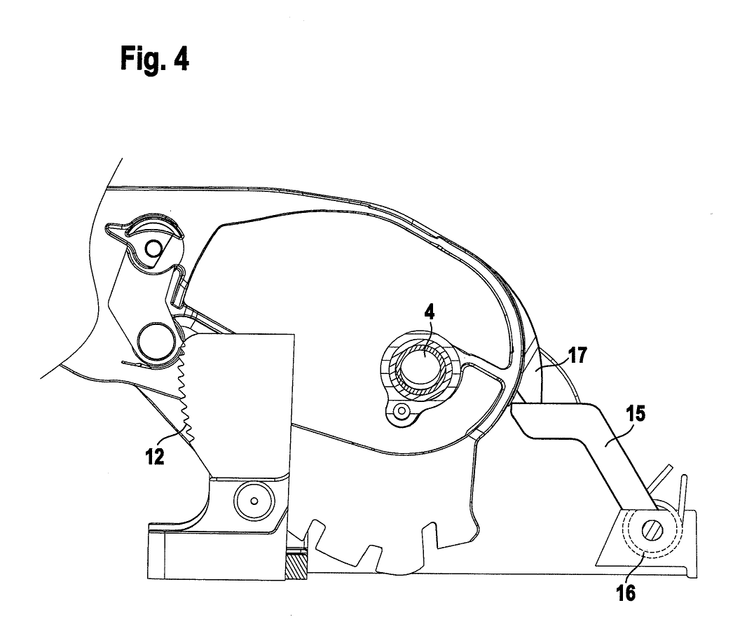

The position-adjustable end stop 15 is positioned so as to pivot on the bottom of the bearing block 3. While the operating mechanism 1 is operational, the position-adjustable end stop 15 is secured in position with the aid of a spring element 16 in the engaged positions as shown in FIGS. 1 and 2, and as shown with further details in FIG. 4, wherein the spring element 16 in that case is a torsion spring.

In the engaged position, the upper segment of the position-adjustable end stop 15 is aligned horizontally, as shown in particular in FIG. 4. If the manual brake lever 2 is pivoted to the maximum upward position (shown in FIGS. 2 and 4), then a stop 17 of the manual brake lever 2 fits against this segment of the position-adjustable end stop 15, thereby preventing a further pivoting of the manual brake lever 2 in upward direction, meaning an overturning of the manual brake lever 2 is prevented. In contrast, however, the manual brake lever 2 can be pivoted unchecked from this position downward in the direction of the starting position.

If the operating mechanism 1 is installed fully assembled into a motor vehicle, then the position-adjustable end stop 15 is no longer accessible and therefore cannot be manipulated, so that the position-adjustable end stop 15 always remains in the engaged position shown in FIGS. 2 and 4, thus ensuring that the manual brake lever 2 cannot be overturned to move past the maximum position setting.

During the installation of the operating mechanism 1 in the motor vehicle, however, the operating mechanism 1 and in particular the position-adjustable end stop 15 are exposed. The bottom region of the bearing block 3 contains bores (not shown herein) through which screws can be inserted to fasten the bearing block 3, for example, to an automobile.

During installation, the manual brake lever 2 can be pivoted past the maximum value setting for the pivoting movement, so that this fastening operation is not hindered by the manual brake lever 2.

FIG. 3 shows the manual brake lever 2 in this overturned position. The view clearly shows that the bores of the bearing block 3 are exposed in this position, so that the screws can be screwed into these bores with the tool W.

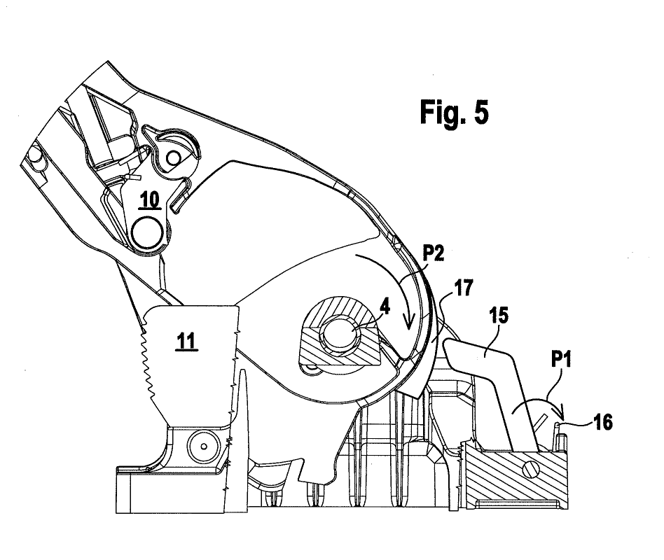

To allow such an overturning of the manual brake lever 2, the position-adjustable end stop 15 can be pulled manually from the engaged position shown in FIG. 4 to the released position in FIG. 5 (see arrow P1 in FIG. 5), counter to the spring force of the spring element 16. The position-adjustable end stop 15 can be held manually in the released position. As a result, the position-adjustable end stop 15 is displaced to the right, out of the way of end stop 17 on the manual brake lever 2. This allows the overturning of the manual brake lever 2, so that the brake lever can be pivoted in arrow direction P2, shown in FIG. 5.

Even when the position-adjustable end stop 15 is in the released position, the manual brake lever 2 can only be overturned to the position shown in FIG. 3, because an end stop 18 on the manual brake lever 2 then comes to rest against an end stop 19 on the bearing block 3, thus preventing a further rotation.

In this position of the manual brake lever 2, the bearing block 3 is attached to the console on the motor vehicle. As soon as this operation is completed, the manual brake lever 2 can be pivoted once more in downward direction, for example until it comes to rest in the starting position. As a result of the spring force exerted by the spring element 16, the position-adjustable end stop 15 is automatically moved back to the engaged position and is securely held in this position by the spring element 16. The position-adjustable end stop 15 is thus secured in the engaged position without adjustment operations.

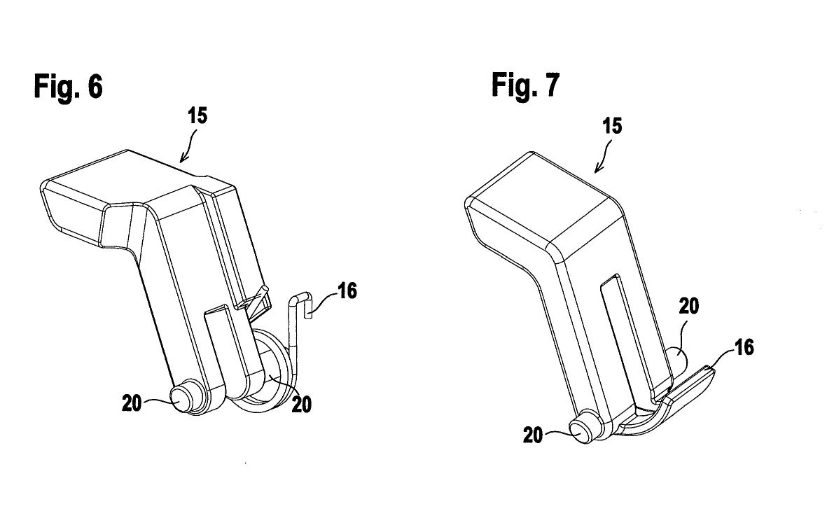

FIGS. 6 and 7 show different embodiments of the position-adjustable end stop 15, which is preferably a plastic injection-molded part.

FIG. 6 shows the embodiment as illustrated in FIGS. 1 and 5, wherein the position-adjustable end stop 15 and the spring element 16, formed by the torsion spring, are separate parts. Cylindrical pivots 20 are formed onto the lower end of the position-adjustable end stop 15. The cylindrical pivots 20 may act as holders positioned in receptacles of the bearing block 3, which functions as the pivot bearing for the position-adjustable end stop 15.

According to a different embodiment, not shown herein, the pivots 20 can be replaced by a cylindrical rod as a separate holder for forming the pivot bearing of the position-adjustable end stop 15.

FIG. 7 shows a further variant of the position-adjustable end stop 15. In contrast to the embodiment shown in FIG. 6, the spring element 16 of FIG. 7 is embodied integrally as one piece with the position-adjustable end stop 15. Otherwise, the embodiment shown in FIG. 7 corresponds to the example shown in FIG. 6. The position-adjustable end stop 15 can comprise a plastic material with elastic properties, so that the spring element 16 has the required elasticity. In addition, the wall thickness of the position-adjustable end stop 15 of FIG. 7 is considerably thinner in the region of the spring element 16 than in the remaining region.

It will be understood that the above description of the present invention is susceptible to various modifications, changes and adaptations, and that the same are intended to be comprehended within the meaning and range of equivalents of the appended claims.

1. An operating mechanism for a parking brake, said operating mechanism comprising:
a manual brake lever pivotably coupled to a bearing block;
a locking device adapted to secure the manual brake lever in a predetermined pivoting position;
an activation rod guided inside the manual brake lever, said activation rod operatively connected to the locking device; and
a position-adjustable end stop movable between an engaged position and a released position, wherein the position-adjustable end stop is adapted to delimit pivotable movement of the manual brake lever to a maximum value setting when in the engaged position, and the position-adjustable end stop is adapted to permit movement of the manual brake lever past the maximum value setting when in the disengaged position.

2. The operating mechanism according to claim 1, further comprising a stop on the manual brake lever, wherein the stop engages the position-adjustable end stop when in the engaged position to delimit pivotable movement of the manual brake lever to the maximum value setting.

3. The operating mechanism according to claim 2, wherein the position-adjustable end stop is pivotably mounted on the bearing block.

4. The operating mechanism according to claim 3, further comprising a spring element that biases the position-adjustable end stop toward the engaged position.

5. The operating mechanism according to claim 4, wherein the position-adjustable end stop is adapted to pivot from the engaged position to the released position counter to the force of the spring element.

6. The operating mechanism according to claim 4, wherein the position-adjustable end stop and the spring element are formed integrally as one piece.

7. The operating mechanism according to claim 4, wherein the position-adjustable end stop and the spring element are separate parts.

8. The operating mechanism according to claim 7, wherein the spring element is attached to a holder.

9. The operating mechanism according to claim 8, wherein the holder and the position-adjustable end stop comprise a single part.

10. The operating mechanism according to claim 1, further comprising:
a first end stop on the bearing block; and
a second end stop on the manual brake lever;
wherein when the position-adjustable end stop is in the released position, the manual brake lever can be pivoted beyond the maximum value setting until the first end stop engages the second end stop.

11. The operating mechanism according to claim 1, wherein the position-adjustable end stop comprises a plastic injection-molded part.
